(19) United States
(12) Patent Application Publication
(10) Pub. No.: US 2004/0123081 A1
(43) Pub. Date: Jun. 24, 2004

(54) Mechanism to increase performance of control speculation

(76) Inventors: Allan Knies, San Francisco, CA (US); Kevin Rudd, Portland, OR (US); Achmed Rumi Zahir, Menlo Park, CA (US); Dale Morris, Steamboat Springs, CO (US); Jonathan K. Ross, Woodinville, WA (US)

Correspondence Address: Leo V. Novakoski, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/327,556

(22) Filed: Dec. 20, 2002

(51) Int. Cl. G06F 9/44

(52) U.S. Cl. 712/225

(57) ABSTRACT

A mechanism for increasing the performance of control speculation comprises executing a speculative load, returning a data value to a register targeted by the speculative load if it hits in a cache, and associating a deferral token with the speculative load if it misses in the cache. The mechanism may also issue a prefetch on a cache miss to speed execution of recovery code if the speculative load is subsequently determined to be on the control flow path.

### BACKGROUND OF THE INVENTION

1. Technical Field

The present invention relates to computing systems, and in particular to mechanisms for supporting speculative execution in computing systems.

2. Background Art

Control speculation is an optimization technique used by certain advanced compilers to schedule instructions for more efficient execution. This technique allows the compiler to schedule one or more instructions for execution before it is known that the dynamic control flow of the program will actually reach the point in the program where the instruction(s) is needed. The presence of conditional branches in an instruction code sequence means this need can only be determined unambiguously at run time.

A branch instruction sends the control flow of a program down one of two or more execution paths, depending on the resolution of an associated branch condition. Until the branch condition is resolved at run time, it cannot be determined with certainty which execution path the program will follow. An instruction on one of these paths is said to be “guarded” by the branch instruction. A compiler that supports control speculation can schedule instructions on these paths ahead of the branch instruction that guards them.

Control speculation is typically used for instructions that have long execution latencies. Scheduling execution of these instructions earlier in the control flow, i.e. before it is known whether they need to be executed, mitigates their latencies by overlapping their execution with that of other instructions. Exception conditions triggered by control speculated instructions may be deferred until it is determined that the instructions are actually reached by the control flow. Control speculation also allows the compiler to expose a larger pool of instructions from which it can schedule instructions for parallel execution. Control speculation thus enables compilers to make better use of the extensive execution resources provided by processors to handle high levels of instruction level parallelism (ILP).

Despite its advantages, control speculation can create microarchitectural complications that lead to unnecessary or unanticipated performance losses. For example, under certain conditions a speculative load operation that misses in a cache may cause a processor to stall for tens or even hundreds of clock cycles, even if the speculative load is subsequently determined to be unnecessary.

The frequency and impact of this type of microarchitectural event on control speculated code depends on factors such as the caching policy, branch prediction accuracy, and cache miss latencies. These factors may vary for different systems depending on the particular program being run, the processor that executes the program, and the memory hierarchy that delivers data to the program instructions. This variability makes it difficult, if not impossible, to assess the benefits of control speculation without extensive testing and analysis. Because the potential for performance losses can be significant and the conditions under which they occur are difficult to predict, control speculation has not been used as extensively as it might otherwise be.

The present invention addresses these and other problems associated with control speculation.

### BRIEF DESCRIPTION OF THE DRAWINGS

The present invention may be understood with reference to the following drawings, in which like elements are indicated by like numbers. These drawings are provided to illustrate selected embodiments of the present invention and are not intended to limit the scope of the appended claims.

FIG. 1 is a block diagram of computer system that is suitable for implementing the present invention.

FIG. 2 is a flowchart representing one embodiment of a method for implementing the present invention.

FIG. 3 is a flowchart representing another embodiment of a method for implementing the present invention.

### DETAILED DISCUSSION OF THE INVENTION

The following discussion sets forth numerous specific details to provide a thorough understanding of the invention. However, those of ordinary skill in the art, having the benefit of this disclosure, will appreciate that the invention may be practiced without these specific details. In addition, various well-known methods, procedures, components, and circuits have not been described in detail in order to focus attention on the features of the present invention.

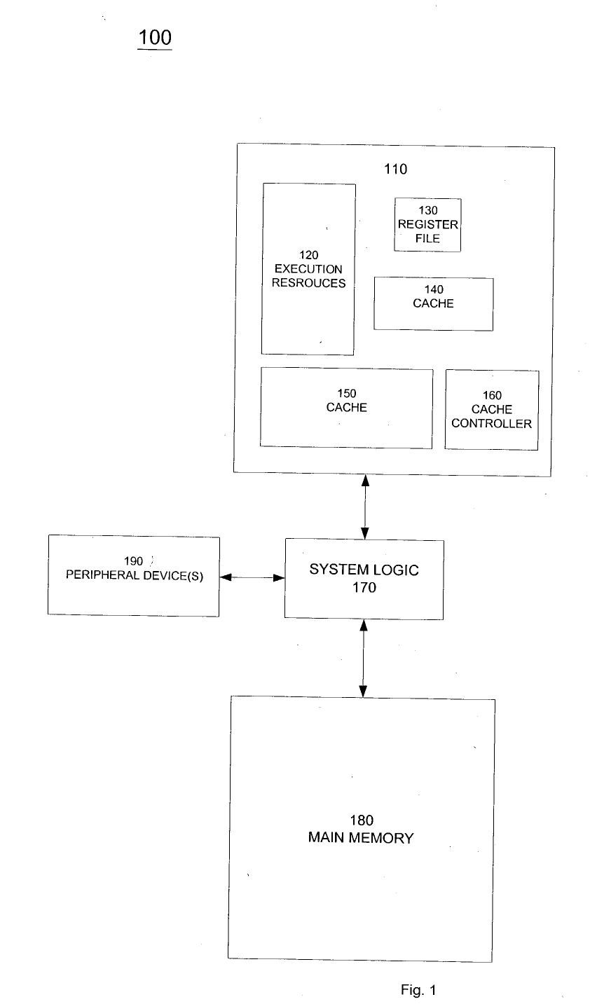

FIG. 1 is a block diagram representing one embodiment of a computing system 100 that is suitable for implementing the present invention. System 100 includes one or more processors 110, a main memory 180, system logic 170 and peripheral devices 190. Processor 110, main memory 180, and peripheral device(s) 190 are coupled to system logic 170 through communication links. These may be, for example, shared buses, point-to-point links, or the like. System logic 170 manages the transfer of data among the various components of system 100. It may be a separate component, as indicated in the figure, or portions of system logic 170 may be incorporated into processor 110 and the other components of the system.

The disclosed embodiment of processor 110 includes execution resources 120, one or more register file(s) 130, first and second caches 140 and 150, respectively, and a cache controller 160. Caches 140, 150 and main memory 180 form a memory hierarchy for system 100. In the following discussion, components of the memory hierarchy are deemed higher or lower according to their response latencies. For example, cache 140 is deemed a lower level cache because it returns data faster than (higher level) cache 150. Embodiments of the present invention are not limited to particular configurations of the components of system 100 or particular configurations of the memory hierarchy. Other computing systems may employ, for example, different components or different numbers of caches in different on and off-chip configurations.

During operation, execution resources 120 implement instructions from the program being executed. The instructions operate on data (operands) provided from a register file 130 or bypassed from various components of the memory hierarchy. Operand data is transferred to and from the register file 130 through load and store instructions, respectively. For a typical processor configuration, a load instruction may be implemented in one or two clock cycles if the data is available in cache 140. If the load misses in cache 140, a request is forwarded to the next cache in the hierarchy, e.g. cache 150 in FIG. 1. In general, requests are forwarded to successive caches in the memory hierarchy until the data is located. If the requested data is not stored in any of the caches, it is provided from main memory 180.

Memory hierarchies like the one described above employ caching protocols that are biased to keep data likely to be used in locations closer to the execution resources, e.g. cache 140. For example, a load followed by an add that uses the data returned by the load may complete in 3 clock cycles if the load hits in cache 140, e.g. 2 cycles for the load and 1 cycle for the add. Under certain conditions, control speculation allows the 3 clock cycle latency to be hidden behind execution of other instructions.

Instruction sequences (I) and (II) illustrate, respectively, a code sample before and after it has been modified for speculative execution. Although it is not shown explicitly in either code sequence, it is assumed that the load and add are separated by an interval that reflects the number of clock cycles necessary to load data from the cache. For example, if the load requires 2 clock cycles to return data from cache 140, a compiler will typically schedule the add to execute 2 or 3 clock cycles later to avoid unnecessary stalls.

| | | | |
|---|---|---|---|
| | cmp.eq | p1, p2 = r5, r6 | |
| | . . . | | (I) |
| (p1) | br.cond | BR-TARGET | |
| | ld | r1 = [r2] | |
| | add | r3 = r1, r4 | |
| | st | [r5] = r3 | |

For sequence (I), the compare instruction (cmp.eq) determines whether a predicate value (p1) is true or false. If (p1) is true, the branch (br.cond) is taken (“TK”) and control flow is transferred to the instruction at the address represented by BR-TARGET. In this case, the load (ld), dependent add (add) and store (st) that follow br.cond are not executed. If (p1) is false, the branch is not taken (“NT”) and control flow “falls through” to the instructions that follow the branch. In this case, ld, add, and st, which follow br.cond sequentially, are executed.

Instruction sequence (II) illustrates the code sample modified by a compiler that supports control speculation.

| | | | |
|---|---|---|---|
| | ld.s | r1 = [r2] | |
| | add | r3 = r1, r4 | |
| | cmp.eq | p1, p2 = r5, r6 | |
| | . . . | | (II) |
| (p1) | br.cond | TARGET | |
| | chk.s | r1, RECOVER | |
| | st | [r5] = r3 | |

For code sequence (II), the load operation (represented by ld.s) is now speculative because the compiler has scheduled it to execute before the branch instruction that guards its execution (br.cond). The dependent add instruction has also been scheduled ahead of the branch, and a check operation, chk.s, has been inserted following br.cond. As discussed below, chk.s causes the processor to check for exceptional conditions triggered by the speculatively-executed load.

The speculative load and its dependent add in code sequence (II) are available for executing earlier than their non-speculated counterparts in sequence (I). Scheduling them for execution in parallel with instructions that precede the branch hides their latencies behind those of the instructions with which they execute. For example, the results of the load and add operations may be ready in 3 clock cycles if the data at memory location [r2] is available in cache 140. Control speculation allows this execution latency to overlap with that of other instructions that precede the branch. This reduces by 3 clock cycles the time necessary to execute code sequence (II). Assuming the check operation can be scheduled without adding an additional clock cycle to code sequence (II), e.g. in parallel with st, the static gain from control speculation is 3 clock cycles in this example.

The static gain illustrated by code sequence (II) may or may not be realized at run time, depending on various microarchitectural events. As noted above, load latencies are sensitive to the level of the memory hierarchy in which the requested data is found. For the system of FIG. 1, a load will be satisfied from the lowest level of the memory hierarchy in which the requested data is found. If the data is only available in a higher level cache or main memory, control speculation may trigger stalls that degrade performance even if the data is not needed.

Table 1 summarizes the performance of code sequence (II) relative to that of code sequence (I) under different branching and caching scenarios. The relative gain/loss provided by control speculation is illustrated assuming a 3 clock cycle static gain from control speculation and a 12 clock cycle penalty for a miss in cache 140 that is satisfied from cache 150.

TABLE 1

| | Cache | Branch | Gain |
|---|---|---|---|
| | Hit/Miss | TK/NT | (Loss) |
| 1 | Hit | NT | 3 |
| 2 | Miss | NT | 3 |
| 3 | Hit | TK | 0 |
| 4 | Miss | TK | (10) |

The first two entries illustrate the relative gain/loss results when the branch is NT, i.e. when the speculated instructions are on the execution path. If the speculated load operation hits or misses in the cache (entries 1 and 2) control speculation provides a 3 clock cycle static gain (e.g. 2 cycles for the load and 1 for the add) over the unspeculated code sequence. Assuming the load and add are separated by 2 clock cycles in both code sequences, the add triggers a stall 2 clock cycles after the load misses in the cache. The net stall of 10 clock cycles (12−2) is incurred for both code sequences—before the NT branch with speculation and after the NT branch without speculation.

The next two entries of Table 1 illustrate gain/loss results for the case in which the branch is TK. For these entries, the program does not need the result(s) provided by the speculated instructions. If the load operation hits in the cache (entry 3), control speculation provides no gain relative to the unspeculated case, because the result returned by the speculatively executed instructions is not needed. Returning an unnecessary result 3 clock cycles early provides no net benefit.

If the load operation misses in the cache, the control speculated sequence (entry 4) incurs a 10 clock cycle penalty (loss) relative to the unspeculated sequence. The control speculated sequence incurs the penalty because it executes the load and add before the branch direction (TK) is evaluated. The unspeculated sequence avoids the cache miss and subsequent stall because it does not execute the load and add on a TK branch. The relative loss incurred by control speculation for a cache miss prior to the TK branch is a 10 clock cycle penalty, even though the result returned by the speculated instructions (ld.s, add) is not needed. If the speculated load misses in a higher level cache and the data is returned from memory, the penalty could be hundreds of clock cycles.

The overall benefit provided by control speculation depends on the branch direction (TK/NT), the frequency of cache misses, and the size of the cache miss penalty. The potential benefits in the illustrated code sequence (3 clock cycle static gain for cache hits on NT branches) can be outweighed by the penalty associated with unnecessary stalls unless the cache hit rate is greater than a configuration-specific threshold (˜80% for our example). For larger cache miss penalties, the cache hit rate must be correspondingly greater to offset the longer stalls. If the branch can be predicted with high certainty to be NT, the cache hit rate may be less important, since this is the case in which the stall is incurred in both code sequences. In general, though, uncertainties about branch direction (TK/NT) and the cache hit rate make it difficult to assess the net benefit of control speculation, and the significant penalty associated with servicing cache misses for unnecessary instructions (greater than 9 clock cycles in the above example) can bias programmers into employing control speculation conservatively or not at all.

Embodiments of the present invention provide a mechanism for limiting the performance loss attributable to the use of control speculation. For one embodiment, a cache miss on a speculative load is handled through a deferral mechanism. On a cache miss, a token may be associated with a register targeted by the speculative load. The cache miss is handled through a recovery routine if the speculated instruction is actually needed. A prefetch-request may be issued in response to the cache miss to speed execution of the recovery routine, if it is needed. The deferral mechanism may be invoked for any cache miss or for a miss in a specified cache level.

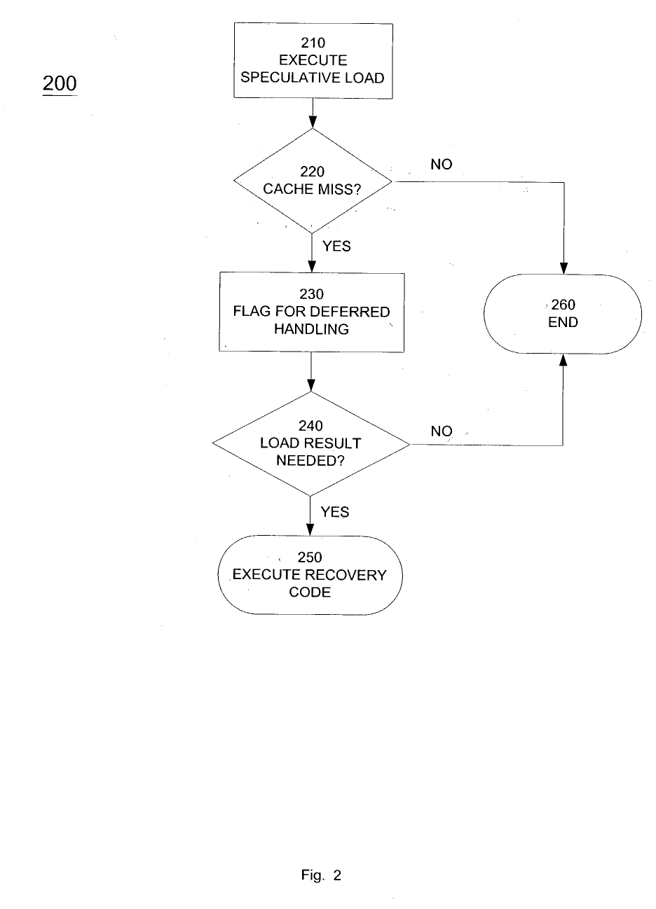

FIG. 2 represents an overview of one embodiment of a method 200 in accordance with the present invention for handling a cache miss by a speculative load. Method 200 is initiated when a speculative load is executed 210. If the speculative load hits 220 in a cache, method 200 terminates 260. If the speculative load misses 220 in the cache, it is flagged 230 for deferred handling. Deferred handling means that the overhead necessary to handle the cache miss is incurred only if it is determined 240 subsequently that the speculative load result is needed. If it is needed, recovery code is executed 250. If it is not needed, method 200 terminates 260.

For one embodiment, a deferred cache miss may trigger recovery if a non-speculative instruction refers to the tagged register, since this only occurs if the speculative load result is actually needed. The non-speculative instruction may be a check operation that tests the register for the deferral token. As discussed below in greater detail, the token may be a token used to signal a deferred exception for speculative instructions, in which case, the exception deferral mechanism is modified to handle microarchitectural events such as the cache miss example described above.

A deferred exception mechanism is illustrated with reference to code sequence (II). As noted above, the check operation (chk.s) that follows the branch is used to determine if the speculative load triggered an exceptional condition. In general, exceptions are relatively complex events that cause the processor to suspend the currently executing code sequence, save certain state variables, and transfer control to low level software such as the operating system and various exception handling routines. For example, a translation look-aside buffer (TLB) may not have a physical address translation for the logical address targeted by a load operation, or the load operation may target privileged code from an unprivileged code sequence. These and other exceptions typically require intervention by the operating system or other system level resources to unwind a problem.

Exceptions raised by speculative instructions are typically deferred until it has been determined if the instruction that triggered the exceptional condition needs to be executed, e.g. is on the control flow path. Deferred exceptions may be signaled by a token, associated with a register targeted by the speculative instruction. If the speculative instruction triggers an exception, the register is tagged with the token, and any instruction that depends on the excepting instruction propagates this token through its destination register. If the check operation is reached, chk.s determines if the register has been tagged with the token. If the token is found, it indicates that the speculative instruction did not execute properly and the exception is handled. If the token is not found, processing continues. Deferred exceptions thus allow the cost of an exception triggered by a speculatively executed instruction to be incurred only if the instruction needs to be executed.

The Itanium® Processor Family of Intel® Corporation, implements a deferred exception handling mechanism using a token referred to as a Not A Thing (NaT). The NaT may be, for example, a bit (NaT bit) associated with a target register that is set to a specified state if a speculative instruction triggers an exceptional condition or depends on a speculative instruction that triggers an exceptional condition. The NaT may also be a particular value (NaTVal) that is written to the target register if a speculative instruction triggers an exceptional condition or depends on a speculative instruction that triggers an exceptional condition. The integer and floating point registers of the Itanium® Processor Family employ Nat bits and NaT values, respectively, to signal deferred exceptions.

For one embodiment of the present invention, the exception deferral mechanism is modified to defer handling of cache misses by speculative load instructions. A cache miss is not an exception, but rather a micro-architectural event which processor hardware handles without interruption or notice to the operating system. In the following discussion, a NaT that is used to signal a microarchitectural event is referred to as a spontaneous NaT to distinguish it from a NaT that signals an exception.

Table 2 illustrates the performance gains/losses for control speculation with a cache miss deferral mechanism relative to control speculation without a cache miss deferral mechanism. As in Table 1, the entries are illustrated for static gain and cache miss penalties of 3 and 12 clock cycles respectively, and the dependent add is assumed to be scheduled for execution 2 clock cycles after the speculated load to account for the 2 clock cycle cache latency.

Two additional factors that affect the relative gain of the deferral mechanism are the number of clock cycles necessary to determine whether the targeted data is in the cache (deferral loss) and the number of clock cycles necessary to execute a recovery routine in the event of a cache miss on an NT branch (recovery loss). For Table 2, it is assumed that presence of data in the cache can be determined within 2 clock cycles of the speculative load. Since the dependent add is scheduled to execute 2 clock cycles after the load, no additional stall is incurred in this case and the deferral loss is zero. If this determination more than 2 clock cycles, the dependent add will stall for the additional cycles and this shows up as a deferral penalty. The recovery loss is assumed to be 15 clock cycles.

Table 2 shows the relative gain(loss) provided by the disclosed cache miss deferral mechanism. All penalty values used in Table 2 are provided for illustration only. As discussed below, different values may apply but the nature, if not the results, of the cost/benefit analysis remain unchanged.

TABLE 2

| | Deferral | Cache Hit/Miss | Branch TK/NT | Gain (Loss) |
|---|---|---|---|---|
| 1 | Yes | Hit | NT | 0 |
| 2 | Yes | Miss | NT | (18) |
| 3 | Yes | Hit | TK | 0 |
| 4 | Yes | Miss | TK | 10 |

Since the deferral mechanism is invoked only on a cache miss, there is no performance impact for speculative loads that hit in the cache. The gain for control speculation with deferral relative to control speculation without deferral is thus zero on a cache hit, independent of the TK/NT status of the branch (entries 1 and 3).

The relative gains for control speculation with and without deferral are evident for the cases in which the speculative load misses in the cache. Undeferred handling of the cache miss on a speculative load incurs the 10 clock cycle penalty regardless of whether the branch is NT or TK. As noted above, cache misses can not be completely eliminated, but incurring a 10 cycle penalty for a cache miss by a speculative instruction that is later determined to not be on the control flow path is particularly wasteful.

The benefit provided by deferred handling of a cache miss on a speculative load depends on the deferral penalty (if any) and the recovery penalty. For Table 2, no deferral penalty is assessed for deferred handling since the number of clock cycles necessary to detect the cache miss is assumed to be no greater than the delay between the speculative load and use, e.g. 2 clock cycles in the example.

If the branch is TK, deferred handling of the cache miss incurs only the deferral penalty, which is zero in the above example. Thus, deferred handling of the cache miss on a TK branch provide again of 10 clock cycles relative to undeferred cache miss handling (entry 4). If the branch is NT, the speculated instructions are necessary for the program flow, and deferred handling incurs a 15 clock cycle recovery penalty. For example, the cache miss may be handled by transferring control to recovery code, which re-executes the speculative load and any speculative instructions that depend on it. Thus, deferred handling of the cache miss on a NT branch provides a loss of 18 clock cycles in the disclosed example relative to undeterred handling (entry 4). The 18 clock cycles include the 15 cycles for the miss handler triggered by the chk.s plus 3 cycles to repeat the speculative code. The 12 cycle cache miss cancels out.

For one embodiment, the deferral mechanism may issue a prefetch request to reduce the load latency if the recovery routine is invoked (cache miss followed by NT branch). The prefetch request initiates return of the targeted data from the memory hierarchy as soon as the cache miss is detected, rather than waiting for the recovery code to be invoked. This overlaps the latency of the prefetch with that of the operations that follow the speculative load. If the recovery code is invoked subsequently, it will execute faster due to the earlier initiation of the data request. A non-faulting prefetch may be employed to avoid the cost of handling any exceptions triggered by the prefetch.

The net cost/benefit of control speculation with the disclosed deferral mechanism and prefetch relative to control speculation without it for the illustrative penalty and gain values are as follows:

(−15)−(3)+12=6 cycle loss per cache miss on a NT branch

(0)−(−10)=10 cycle gain per cache miss on a TK branch.

Thus, including the prefetch mechanism reduces entry 2 in Table 2 from 18 to 6 cycles. The net benefit provided by combining control speculation with the disclosed deferral thus depends on the branch behavior, the frequency of cache misses, and the various penalties (recovery, stall, deferral) that apply. For example, the benefit provided by the deferral mechanism occurs at lower cache miss frequencies when cache miss penalties are higher. Similarly, if the sum of the penalties for tagging the speculated instruction(s) (deferral penalty) and executing the recovery code (recovery penalty) is no greater than the stall penalty, control speculation using the deferral mechanism provides better performance than control speculation without it, regardless of cache miss frequencies, etc.

If the sum of the deferral and recovery penalties is greater than the stall penalty, the trade off depends on the deferral penalty and the frequency with which it is incurred and discarded (cache miss followed by a TK branch) versus the recovery penalty and the frequency with which it is incurred (cache miss followed by an NT branch). As discussed below, processor designers can select the conditions under which cache miss deferral is implemented for given recovery and deferral penalties to ensure that the negative potential of cache miss deferral for the NT case is nearly zero. Decisions regarding when to defer cache misses can be done system wide with a single heuristic for all ld.s, or on a per load basis using hints. In general, the downside potential of the deferral mechanism is smaller, the longer the cache miss latency is. This downside can be substantially eliminated by selecting an appropriate cache level for which cache miss deferral is implemented.

Given the dependence of the cost/benefit provided by the disclosed deferral mechanism on various parameters, e.g. miss rate in a cache, the stall penalty associated with a miss on a subsequent use of the data, etc., it may be useful to provide some flexibility as to whether or not the deferral mechanism is invoked. For one embodiment, the deferral mechanism may be invoked if a speculative load misses in a specified cache level. In a computing system like that of FIG. 1, having two levels of cache, a speculative load may generate spontaneous NaT if it misses in a particular one of these caches, e.g. cache 140.

Cache level specific deferral may also be made programmable. For example, speculative load instructions in the Itanium® Instruction Set Architecture (ISA) include a hint field that may used to indicate a level in the cache hierarchy in which the data is expected to be found. For another embodiment of the invention, this hint information may be used to indicate the cache level for which a cache miss triggers the deferral mechanism. A miss in the cache level indicated by the hint may trigger a spontaneous NaT.

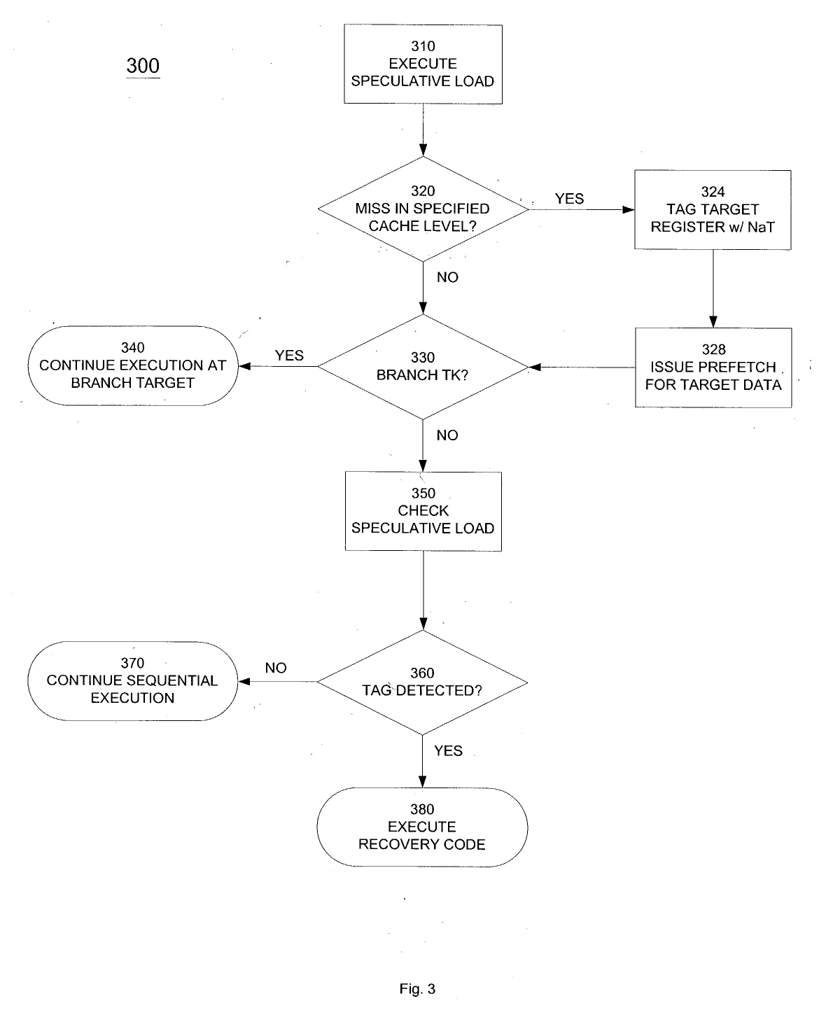

FIG. 3 is a flowchart that represents another embodiment of a method 300 in accordance with the present invention. Method 300 is initiated by execution 310 of a speculative load. If the speculative load hits 320 in a specified cache, method 300 awaits resolution 330 of the branch instruction. If the speculative load misses 320 in the specified cache level, its target register is tagged 324 with a deferral token, e.g. spontaneous NaT, and a prefetch request is issued 328. The token may be propagated through the destination registers of any speculative instruction that depend on the speculative load.

If the branch is taken (TK) 330, execution continues 340 with the instruction at the target address of the branch. In this case, the result of the speculative load is not needed, so no additional penalty is incurred. If the branch is not taken, the speculative load is checked 350. For example, the value in the register targeted by the speculative load may be compared with the value specified for NaTs or the state of a NaT bit may be read. If the deferral token is not detected 360, the result(s) returned by the speculatively executed instructions is correct, and execution continues 370 with the instruction that follows the load check.

If the deferral token is detected 360, a cache miss handler is executed 380. The handler may include the load and any dependent instructions that had been scheduled for speculative execution. The latency for the non-speculative load is reduced by the prefetch (block 328), which initiates return of the target data from a higher level of the memory hierarchy in response to the cache miss.

In addition to selecting a cache level for which speculative load misses are deferred, it may be desirable to disable the cache miss deferral mechanism for certain code segments that employ speculative loads. For example, critical code segments such as the operating system and other low level system software typically require deterministic behavior. Control speculation introduces indeterminacy because excepting conditions triggered by speculatively executed instructions may or may not lead to execution of a corresponding exception handler, depending on program control flow.

Such critical code segments may still employ speculative loads for performance reasons, provided they ensure that the exception handler is never (or always) executed in response to a speculative load exception, regardless of how the guarding branch instruction is resolved. For example, a critical code segment may execute a speculative load under conditions that never trigger exceptions or it may use the token itself to control the program flow. A case in point is an exception handler for the Itanium Processor Family that employs a speculative load to avoid the overhead associated with nested faults.

For the Itanium Processor Family, a handler responding to a TLB miss exception must load an address translation from a virtual hardware page table (VHPT). If the handler executes a non-speculative load to the VHPT, this load may fault, leaving the system to manage the overhead associated with a nested fault. A higher-performance handler for the TLB fault executes a speculative load to the VHPT and tests the target register for a NaT by executing a Test NaT instruction (TNaT). If the speculative load returns a NaT, the handler may branch to an alternative code segment to resolve the page table fault. In this way, the TLB miss exception handler never executes the VHPT miss exception handler on a VHPT miss by the speculative load.

Because embodiments of the disclosed cache miss deferral mechanism may trigger deferred exception-like behavior, they can also undermine the deterministic execution of critical code segments. Since this deferral mechanism is driven by microarchitectural events, the opportunities for non-deterministic behavior may be even greater.

Another embodiment of the present invention, supports disabling of cache miss deferral under software control, without interfering with the use of speculative loads in critical code segments or the safeguards in place to prevent non-deterministic behavior. This embodiment is illustrated using the Itanium Architecture, which controls aspects of exception deferral through fields in various system registers. For example, the processor status register (PSR) maintains the execution environment, e.g. control information, for the currently executing process, the Control Registers capture the state of the processor on an interruption; and the TLB stores recently used virtual-to-physical address translations. Persons skilled in the art and having the benefit of this disclosure will recognize the modifications necessary to apply this mechanism to other processor architectures.

The conditions under which deferred exception handling is enabled for an Itanium processor is represented by the following logic equation:

!PSR.ic|(PSR.it && ITLB.ed && DCR.xx)

The first condition under which exceptions are deferred is controlled by the state of an interrupt collection (ic) bit in the processor status register (PSR.ic). If PSR.ic=1, various registers are updated to reflect the processor state when an interruption occurs, and control passes to an interruption handler, i.e. interruptions are not deferred. If PSR.ic=0, processor state is not saved. If an interruption occurs without saving the processor state, the system will crash in most cases. Therefore, the operating system is designed so that no exceptions are triggered if PSR.ic=0.

Critical code may include a speculative load with PSR.ic=0 (interruption state collection disabled) if it also provides an alternate mechanism to ensure that the interruption is not raised. In preceding example, this is done by testing for the NaT bit branching to a different code segment if the NaT is detected.

The second condition under which exceptions are deferred arises when: (1) address translation is enabled (PSR.it=1); the ITLB indicates that recovery code is available (ITLB.ed=1); and the control register indicates that the exception corresponds to one for which deferral is enabled (DCR.xx=1). The second condition is the one that applies normally to application level code that includes control speculation.

To preserve the use of speculative loads by critical code segments, while enabling cache miss deferral for selected application level program's, cache miss deferral may be enabled through the following logic equation:

(PSR.ic && PSR.it && ITLB.ed)

This condition ensures that cache miss deferral will not be enabled under those conditions for which exception deferral is unconditionally enabled, e.g. PSR.ic=0. For application code, exception deferral is enabled according to the state of PSR.it, ITLB.ed and the corresponding exception bits in DCR, while cache miss deferral is enabled according to the state of PSR.it, ITLB.ed and PSR.ic.

A mechanism has been provided for limiting the potential performance penalty of cache misses on control speculation to support more widespread use of control speculation. The mechanism detects a cache miss by a speculative load and tags a register targeted by the speculative load with a deferral token. A non-faulting prefetch may be issued for the targeted data in response to the cache miss. An operation to check for the deferral token executes only if the result of the speculative load is needed. If the check operation executes and it detects the deferral token, recovery code handles the cache miss. If the check operation does not execute or it executes and does not detect the deferral token, the recovery code is not executed. The deferral mechanism may be triggered on misses to specified cache level and the mechanisms may be disabled entirely for selected code sequences.

The invention has been illustrated for the case in which the deferral mechanism is invoked on a speculative load miss in a cache, but it may also be employed for other microarchitectural events triggered by speculative instructions that can have significant performance implications. The invention is to be limited only by the spirit and scope of the appended claims.

We claim:

1. A method for processing a speculative load, comprising:
issuing the speculative load;
returning a data value to a register targeted by the speculative load if the speculative load hits in a cache; and
tagging the targeted register with a deferral token if the speculative load misses in a cache.

2. The method of claim 1, further comprising issuing a prefetch if the speculative load misses in the cache.

3. The method of claim 2, wherein issuing the prefetch instruction comprises converting the speculative load to a prefetch.

4. The method of claim 1, wherein tagging the targeted register further comprises:
comparing a cache level indicated for the speculative load with a level of the cache; and
tagging the targeted register if the levels match.

5. The method of claim 1, wherein the deferral token is a bit value and tagging the targeted register comprises setting a bit field associated with the targeted register to the bit value.

6. The method of claim 1, wherein the deferral token is a first value and tagging the targeted register comprises writing the first value to the targeted register.

7. The method of claim 1, wherein tagging the targeted register comprises tagging the targeted register with a deferral value if cache miss deferral is enabled and the speculative load misses in the cache.

8. The method of claim 1, further comprising:
checking for the deferral token if the speculative load is needed; and
transferring control to a recovery routine if the deferral token is detected.

9. A system comprising:
a cache;
a register file;
an execution core; and
a memory to store instructions that may be processed by the execution core to:
issue a speculative load to the cache; and
tag a register in the register file targeted by the speculative load if the speculative load misses in the cache.

10. The system of claim 9, wherein the register is tagged by writing a first value to an associated bit, responsive to the speculative load missing in the cache.

11. The system of claim 9, wherein the register is tagged by writing a second value to the register, responsive to the speculative load missing in the cache.

12. The system of claim 9, wherein the stored instructions may be processed by the execution core to issue a prefetch to an address targeted by the speculative load if the speculative load misses in the cache.

13. The system of claim 9, wherein the cache includes at least first and second level caches and the targeted register is tagged if the speculative load misses in a specified one of the first and second level caches.

14. The system of claim 9, wherein the register file targeted by the speculative load is tagged if a cache miss deferral mechanism is enabled and the speculative load misses in the cache.

15. A machine-readable medium on which are stored instruction that may be executed by a processor to implement a method comprising:
executing a first speculative operation;
associating a deferral token with the first speculative operation if it triggers a microarchitectural event.

16. The machine-readable medium of claim 15, wherein the first speculative operation is a speculative load operation and the microarchitectural event is a miss in a cache.

17. The machine readable medium of claim 16, wherein associating a deferral token comprises associating the deferral token with the speculative load operation if the speculative load operation misses in the cache and cache miss deferrals are enabled.

18. The machine readable medium of claim 16, wherein the method further comprises reading a control register to determine if a deferral mechanism is enabled before associating the deferral token with the speculative load operation.

19. The machine readable medium of claim 18, wherein the method further comprises:
executing a second speculative operation that depends on the speculative operation; and
associating a deferral token with the second speculative operation if a deferral token is associated with the speculative load operation.

20. The machine readable medium of claim 16, further comprising issuing a prefetch request to an address targeted by the speculative load operation if the speculative load operation misses in the cache.
